(19) United States
(12) Patent Application Publication
(10) Pub. No.: US 2002/0113704 A1
(43) Pub. Date: Aug. 22, 2002

(54) Wireless transmitting security cable

(76) Inventor: Brian K. Hess, Columbus, OH (US)

Correspondence Address: Brian K. Hess, 958 North High Street, Columbus, OH, 43201, US

(21) Appl. No.: 10/127,204

(22) Filed: Apr. 22, 2002

Related U.S. Application Data
(63) Continuation of application No. 09/665,829, filed on Sep. 20, 2000.

(51) Int. Cl. G08B 13/12

(52) U.S. Cl. 340/568.2; 340/571

(57) ABSTRACT

A security cable for protecting transportable items. The security cable produces a wireless alarm transmission to a remote location upon the detection of a security breach. The security cable may consist of two sections of conductive cable emanating from an enclosure. The enclosure houses means to monitor at least one characteristic of the cable after the cable ends are joined. A communications device is secured within the enclosure and adapted to initiate and complete a wireless transmission to a remote location in response to certain changes in the monitored characteristic of the cable. Embodiments of the security cable may be used independently or in conjunction with an existing alarm system. The security cable may further utilize an integral motion detector, may communicate with other remote wireless transmitting devices, and may possess other features such as an audible siren, a strobe light, a programmable keypad, a wireless receiver, indicator lights and a tamper switch.

### BACKGROUND AND SUMMARY OF THE INVENTION

Various types of signal transmitting alarm devices exist for providing protection of homes and businesses and the like. These alarm devices typically consist of hardwired alarm systems, which send a signal to a security monitoring company upon detection of a security breach. A portable alarm system that can provide this function is also in existence. However, there is a lack of such a device capable of providing adequate protection of transportable items. Such items may include, for example, bicycles, motorcycles, or construction equipment.

Various locking devices have been constructed for this purpose. However, such locking devices generally may be defeated provided a would-be thief or intruder is given sufficient time—and transportable items are often left unattended in remote areas. This may be especially true with respect to construction equipment, and perhaps to a lesser extent, bicycles. Thus, with little chance of detection, a thief will often have ample time to defeat a known type locking device, often by breaking or cutting, for example.

Additionally, smaller transportable items, such as bicycles, small pieces of construction equipment, and even motorcycles, are often carried or hauled away with a known-type locking device still attached. This occasionally occurs even with larger transportable items, such as by towing or placement into a truck or other means of transportation.

Therefore, a need exists for a security device that is capable of protecting transportable items, that is not easily defeated, and that will function to provide notice of a security breach even in remote areas. The wireless transmitting security cable of the present invention satisfies this need.

In one embodiment of the present invention, the wireless transmitting security cable has an enclosure which houses a transmitter, sensor, and battery, and may also house a tamper switch and other electronic components. A cable having male and female plug ends is electrically connected to the sensor within the enclosure. The security cable is designed for wireless communication with an existing alarm system, such as a typical hardwired alarm system or a portable alarm system. The security cable is place around an item to be protected, and the male and female plug ends are joined. Thereafter, any attempt to cut or short-circuit the cable, or to open or destroy the enclosure, will result in detection by the sensor and the wireless transmission of an alarm signal to the existing alarm system. The existing alarm system may then send a corresponding alarm signal to a security monitoring company or the alarm system user, for example. The security cable may also contain a motion detector, to further detect attempts to defeat the security cable or remove the security cable from the item to be detected.

In another embodiment of the present invention, the enclosure of the security cable may contain a cellemetry radio or other wireless communication device in electrical communication with a microprocessor. This embodiment of the security cable is capable of independently transmitting an alarm signal to a remote location such as a security monitoring company or the alarm system user, for example, thereby eliminating any dependence on an existing alarm system. This embodiment also preferably utilizes a control panel, such as a keypad, for programming the security cable.

An additional embodiment of the present invention contemplates the use of a GPS receiver in conjunction with the cellemetry radio or other wireless transmission device, such that any alarm signal emanating from the security cable may also contain location data. This may be especially useful, for example, if the item to which the security cable is attached is in a remote location, or if the item has been removed from its original location.

The wireless transmitting security cable of the present invention may utilize cables and enclosures of various size and composition. A multitude of connectors may also be used, including, for example, a locking device. The security cable may also have other features, such as retractable cables, a rechargeable battery, a battery level indicator, a keypad or other on/off/arming means, an alarm siren, or a strobe light. Additionally, a wireless receiver may be placed within the enclosure to allow remote arming/disarming of the security cable, and for optional communication with other remote wireless transmitting devices, such as remote motion sensors and remote control units.

### BRIEF DESCRIPTION OF THE DRAWINGS

In addition to the novel features and advantages mentioned above, other objects and advantages of the present invention will be readily apparent from the following descriptions of the drawings and exemplary embodiments, wherein like reference numerals across the several views refer to identical or equivalent features, and wherein:

FIG. 1 illustrates one embodiment of a wireless transmitting security cable of the present invention, wherein cable sections are connected via a male and female plug end and optional features are located on an enclosure portion;

FIG. 2 illustrates another preferred embodiment of the wireless transmitting security cable of the present invention, wherein the cable sections are connected via a locking mechanism and optional features are located on an enclosure portion;

FIG. 3 shows an embodiment of a control portion having a wireless transmitter adapted for communication with an existing alarm system, said control portion shown in FIGS. 1-2 to be located within a housing portion of the wireless transmitting security cable of the present invention;

FIG. 4 illustrates another embodiment of the control portion having a wireless communication device and microprocessor adapted to independently communicate with a remote location, said control portion shown in FIGS. 1-2 to be located within a housing portion of the wireless transmitting security cable of the present invention; and

FIG. 5 depicts an additional embodiment of the control portion illustrated in FIG. 4, with the addition of a GPS receiver for providing location data.

### DETAILED DESCRIPTION OF THE EXEMPLARY EMBODIMENT(S)

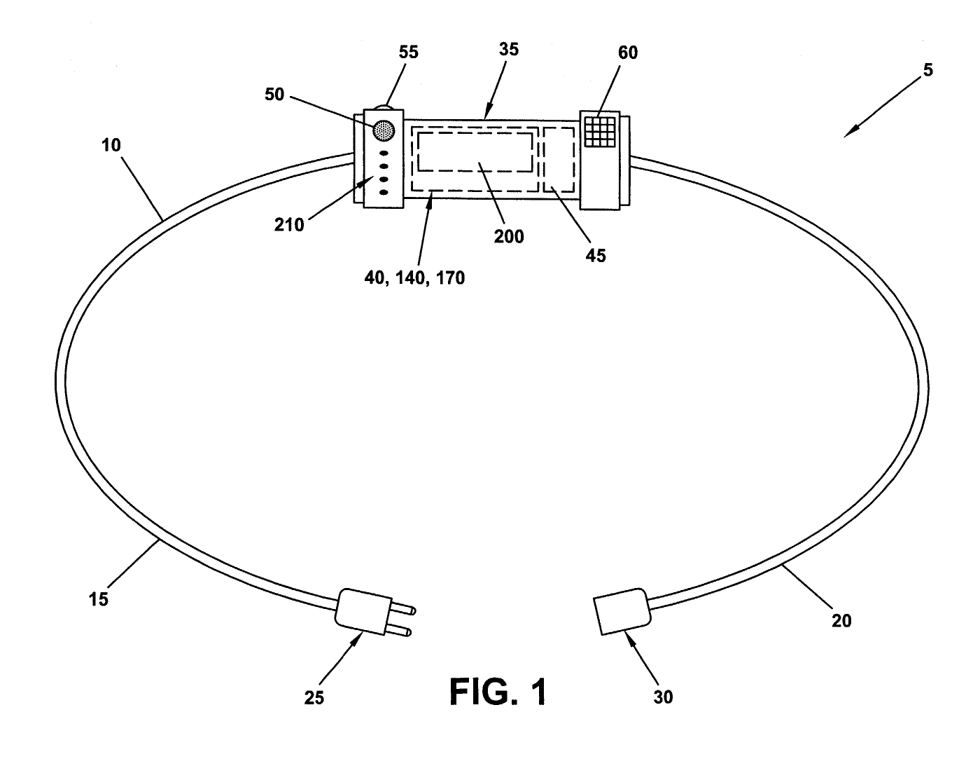

One embodiment of the wireless transmitting security cable 5 of the present invention is illustrated in FIG. 1. The security cable 5 can be seen to have a conductive cable portion 10 which may be placed around or through, or may be otherwise removably affixed to an item to be protected. The individual sections 15, 20 of cable are preferably adapted to allow for connection of their respective ends. Although the ends of each section of cable could simply terminate in wire leads that may be twisted or similarly joined, it is preferred that a connector be provided for this purpose. In FIG. 1, the first section of cable 15 is shown to terminate in a male plug end 25, and the second section of cable 20 is shown to terminate in a female plug end 30. Although FIG. 1 illustrates the use of male and female plug ends, the term connector, as used herein, is meant to include any type of plug, lock mechanism or other connecting device that may be placed on the ends of each section 15, 20 of cable and joined together, thereby allowing a completed circuit to be formed by the cable 10.

The cable portion 10 may be constructed of various materials. For example, the cable portion 10 may consist of rubber or plastic coated wires, as may be found in a common extension cord, or may possess protective jacketing, such as a stainless steel sleeve. Although there are various suitable materials available from which the outer surface of the cable portion 10 may be formed, preferably the outer surface of the cable portion is constructed from a material that is at least resistant to the elements.

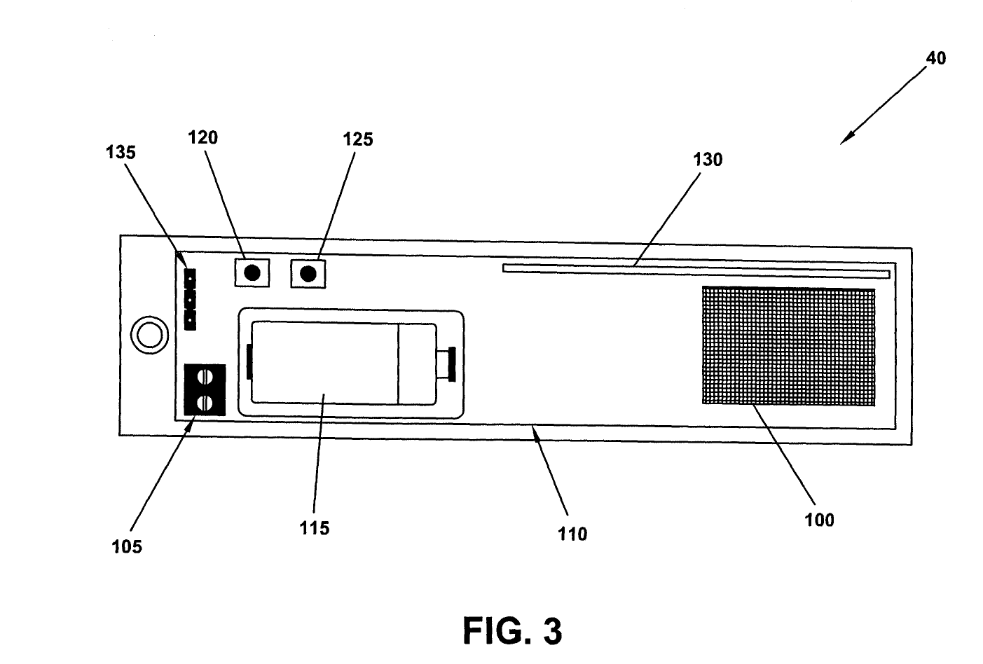

The wireless transmitting security cable 5 can also be observed to have an enclosure 35 for housing a control portion 40 (see FIGS. 3-5). One end of each of the individual sections 15, 20 of cable enters the enclosure 35 and is placed in electrical communication with a sensor, such as a contact switch, which is part of the control portion 40 located therein and is provided to monitor one or more characteristics of the security cable 5. Although the enclosure is shown to be of cylindrical shape in FIG. 1, a multitude of other shapes are also possible. The enclosure may also be of varying size, depending on the application in which it will be used. In the embodiment of the present invention shown in FIG. 1, the enclosure 35 is approximately 6 inches in length and approximately 2 inches in diameter.

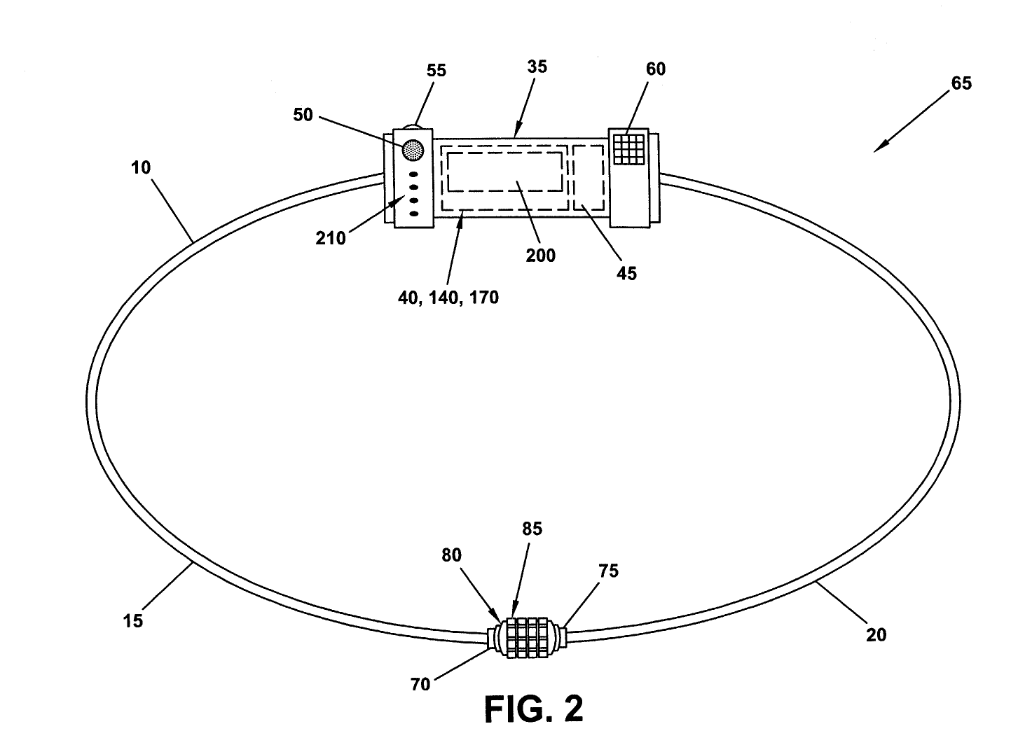

While a wide variety of materials may be used to construct the enclosure 35, in the embodiments shown in FIGS. 1 and 2, the enclosure is constructed of plastic. For example, the enclosure 35 may be constructed using existing PVC tubing. The enclosure 35 may also be molded from a variety of plastic resins, including, without limitation, PVC and polycarbonate. While the enclosure 35 may also be constructed of steel, aluminum, or other metals, a plastic material is preferable for its ability to more easily pass electronic signals. The material selected for use in the enclosure 35 should preferably have good strength and impact resistance to help circumvent attempts to disable the wireless transmitting security cable 5 by destroying the enclosure 35 and the components therein.

While not shown in FIGS. 1-2 for purposes of clarity, it is also contemplated that one or both of the cable sections 15, 20 may be substantially retracted into the housing 35. A spring-loaded reel or other known device may be placed within the housing 35 to provide for retraction of the cable sections 15, 20. Alternatively, space may be provided in the housing 35 to allow the cable sections 15, 20 to be manually inserted therein.

The enclosure 35 may also be used to house other optional features of the security cable 5. The enclosure 35 may include a motion detector 45 for sensing movement of the enclosure. The motion sensor may be adapted, for example, to refrain from activation until a pre-determined amount of movement is detected, and may also be adapted to allow remote arming/disarming, as discussed below. The enclosure may also include a siren 50 and/or a strobe light 55 for providing an audible and visual indication of an unauthorized attempt to disable or remove the security cable 5. A keypad 60 or other type of secure on/off switch may also be provided to allow the user of the security cable 5 to enable or disable the monitoring function, although such is not required. The keypad may also be used to program certain embodiments of the security cable 5. If provided, the motion detector 45, siren 50, strobe light 55, keypad 60 or other on/off switch may be placed in various positions on and within the enclosure 35.

An alternate embodiment of a wireless transmitting security cable 65 of the present invention is illustrated in FIG. 2. As can be seen in FIG. 2, this embodiment of the security cable 65 is similar to the embodiment of FIG. 1. The security cable 65 also has a cable portion 10 having individual sections 15, 20. However, in this embodiment, the end 70 of the first section of cable 15 and the end 75 of the second section of cable 20 are adapted to terminate in a lock mechanism 80. In FIG. 2, the lock mechanism 80 is shown to possess tumblers 85 for unlocking the lock mechanism. However, it should be understood that other lock types may also be substituted, such as, for example, key locks or other types of combination locks. This embodiment of the security cable 65 provides the added protection of requiring the unlocking of the lock mechanism 80 prior to the disconnection of the cable ends 70, 75. This embodiment is also shown to have the enclosure 35 for housing the control portion 40 of the security cable 65, and may also possess retractable cables and the other optional features as discussed above with reference to the embodiment of FIG. 1.

One embodiment of the control portion 40 of the security cable of the present invention can be seen in FIG. 3. Although the control portion 40 may be used in multiple embodiments of the security cable, such as those shown in FIGS. 1 and 2, for purposes of clarity the control portion 40 will be described with reference to FIG. 1 only.

In the particular embodiment of FIG. 3, the control portion 40 is adapted for communication with an existing hardwired or portable alarm system. The control portion 40 contains a transmitter 100, such as a radio frequency (RF) transmitter, for transmitting wireless signals to the existing alarm system. The control portion 40 also has a sensor, such as a contact switch in communication with the cable sections 15, 20, to which connection may be made such as with the terminals 105 shown in FIG. 3. The sensor is provided to monitor certain electrical characteristics of the security cable 5, such as, for example, current flow and/or resistance.

A power supply, preferably a rechargeable battery 115, is provided to supply power to the security cable 5. Preferably, the transmitter 100, sensor and battery are mounted to a control board 110 for stability and simplicity. Once the ends 25, 30 of the cable sections 15, 20 are connected, any unauthorized disconnection thereof will be detected by the sensor, thereby causing the wireless transmitter 100 to send an alarm transmission to the existing alarm system.

The control portion 40 preferably also contains a tamper switch 125. The tamper switch 125 is designed to cause the transmission of an alarm signal if dislodged or adequately moved within the housing 35, such as may occur during an unauthorized attempt to deactivate the security cable 5. The control portion 40 preferably also possesses an antenna 130 located within the enclosure 35 for assisting in the transmission of wireless communications therefrom. A reset button 120 and a programming header 135 may also be provided. The programming header 135 allows the control portion 40 to be programmed so that the security cable 5 may register with the existing alarm system.

As mentioned above, this embodiment of the control portion 40 is adapted for communication with an existing hardwired or portable alarm system. Such a portable alarm system is disclosed in U. S. Pat. Nos. 5,587,701; 5,777,551; 5,850,180 and 6,049,273, all of which are hereby incorporated by reference herein. In this embodiment, the security cable 5 will transmit a signal, via the wireless transmitter 100 to the existing alarm system upon a breach of the security cable 5. While the portable alarm system referred to herein is capable of receiving such a signal, a receiver will generally need to be connected to a hardwired alarm system to allow for the receipt of the alarm signal from the security cable 5. In response to receipt of a signal from the security cable 5, the existing alarm system will preferably transmit an alarm communication to, for example, the user of the security cable, a call station or central monitoring station of a security monitoring company, or another location specified by the user, such as an electronic mail address or Internet URL.

Preferably, the security cable 5 is programmed using the programming header 135 so that the security cable may be particularly identified by the existing alarm system. Once the security cable 5 is properly programmed, it preferably registers with the existing alarm system as a monitored zone. The status of the security cable 5 may then preferably be observed by visually checking a zone status indicator, such as an LED located on the existing alarm unit. When the security cable 5 is used in conjunction with an existing alarm system, as described above, a breach of the security cable preferably causes the same alarm functions as would a breach of any other monitored zone.

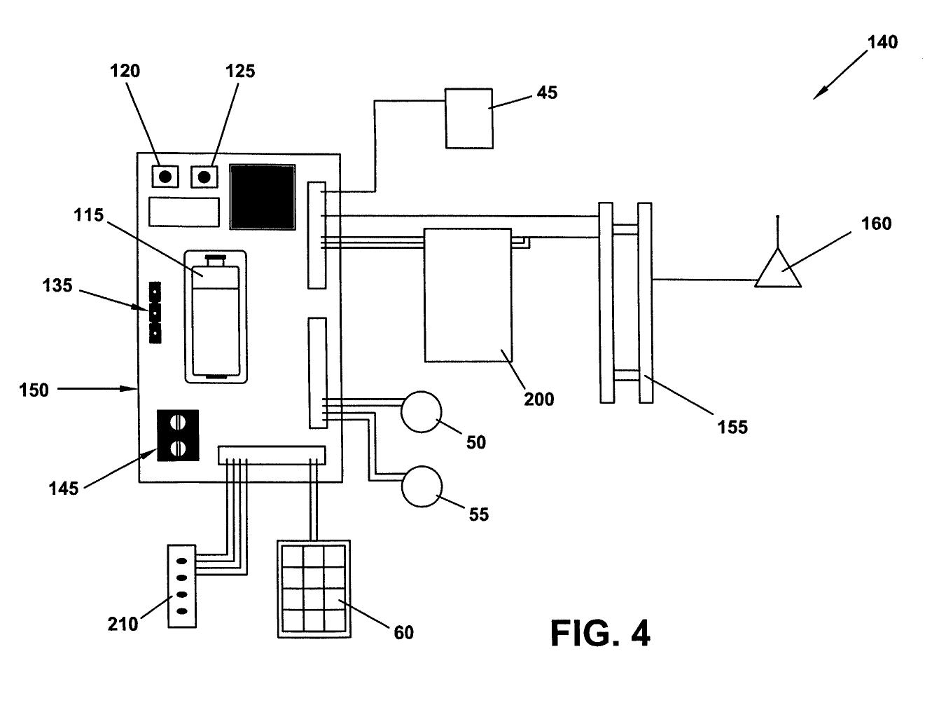

An alternate embodiment of the control portion 140 of the security cable 5 of the present invention may be seen by reference to FIG. 4. Although the control portion 140 may be used in multiple embodiments of the security cable, such as those shown in FIGS. 1 and 2, for purposes of clarity the control portion 140 will be described with reference to FIG. 1 only.

The control portion 140 preferably contains a microprocessor 150, which is in electrical communication with other electronic components of the control portion. Terminals 145 are preferably provided for connection of the cable portion 10 of the security cable to the microprocessor 150. A sensor, in electrical communication with the microprocessor, is provided to monitor certain electrical characteristics of the security cable 5, such as, for example, current flow and/or resistance.

In this embodiment, a wireless communication device 155, such as a cellemetry radio, replaces the wireless transmitter 100 depicted in FIG. 3. A cellemetry radio 155, for example, allows the security cable 5 to directly transmit a wireless alarm communication over the data transmission channel of a typical cellular network. The alarm communication may be transmitted, for example, to either the user of the security cable, a call station or central monitoring station of a security monitoring company, or another location specified by the user, without the need for an existing alarm system. A power supply 115, preferably a rechargeable battery, provides power to the security cable 5. In this manner, the security cable 5 may autonomously operate to provide wireless security protection.

The microprocessor 150 preferably also communicates with a tamper switch 125. The tamper switch 125 is designed to cause the transmission of an alarm communication if dislodged or adequately moved within the housing, such as may occur during an unauthorized attempt to deactivate the security cable 5. The control portion 140 preferably also possesses an antenna 160 for assisting in the transmission of cellemetry radio or other wireless communications from within the enclosure 35.

Although capable of providing security monitoring independent of an existing alarm system, the security cable 5 using the embodiment of the control portion 140 shown in FIG. 4 may preferably also be programmed using a programming header 135, so that the security cable may be particularly identified if used in conjunction with an existing alarm system. In such applications, a wireless transmitter (not shown), such as that utilized in the embodiment of the control portion of FIG. 3, is also placed in electrical communication with the microprocessor 150 to allow communication with the existing alarm system. Once the security cable 5 is properly programmed, it will then preferably register with the existing alarm system as a monitored zone. The status of the security cable 5 may then preferably be observed by visually checking a zone status indicator, such as an LED located on the existing alarm unit.

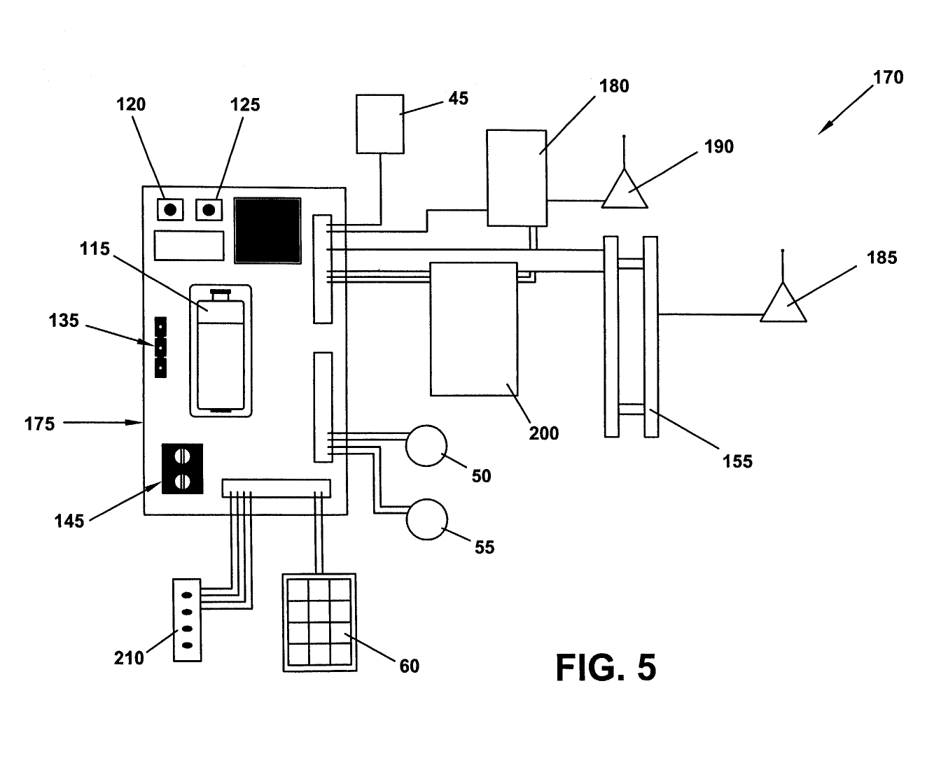

Another embodiment of the control portion 170 of the security cable 5 of the present invention is illustrated in FIG. 5. Although the control portion 170 may be used in multiple embodiments of the security cable, such as those shown in FIGS. 1 and 2, for purposes of clarity the control portion 170 will be described with reference to FIG. 1 only.

This embodiment is similar to the embodiment of FIG. 4, with the addition of a GPS receiver 180 in electrical communication with a microprocessor 175. As in the embodiment of FIG. 4, terminals 145 are preferably provided for connection of the cable portion 10 of the security cable to the microprocessor 175. In this embodiment, the wireless communication device 155, such as a cellemetry radio, is used in conjunction with the GPS receiver 180. The combination of a cellemetry radio 155 and the GPS receiver 180, for example, allows the security cable 5 to directly transmit location data along with an alarm communication over the data channel of a typical cellular network as indicated by the sensor. The security cable 5 may transmit the alarm communication and location data to either the user of the security cable, a call station or central monitoring station of a security monitoring company, or another location specified by the user, without the need for an existing alarm system. As in the embodiment of FIG. 4, a power supply, such as a rechargeable battery 115 provides power to the microprocessor 175 and other components of the security cable 5.

The microprocessor 175 preferably also communicates with a tamper switch 125. The tamper switch 125 is designed to cause the transmission of an alarm communication and location data if dislodged or adequately moved within the housing 35, such as during an unauthorized attempt to deactivate the security cable 5. The control portion 170 preferably also possesses at least one antenna 185 for transmitting wireless alarm communications and location data from within the enclosure 35, and may also possess an additional antenna 190 for assisting in the receipt of GPS data.

Preferably, the security cable 5 utilizing the embodiment of the control portion 170 shown in FIG. 5 may be programmed using a programming header 135, so that the security cable may be particularly identified if used in conjunction with an existing alarm system. In such applications, a wireless transmitter (not shown), such as that utilized in the embodiment of the control portion of FIG. 3, is also placed in electrical communication with the microprocessor 175 to allow communication with the existing alarm system. Once the security cable 5 is properly programmed, it will preferably register with the existing alarm system as a monitored zone. The status of the security cable 5 may then preferably be observed by visually checking a zone status indicator, such as an LED located on the alarm unit.

It is possible to substitute other types of wireless communication devices for the wireless transmitter 100 and cellemetry radio 155 of FIGS. 3-5. For example, a cellular radio may be used to transmit alarm signals over the voice channel of a typical cellular network, or a pager transmission device may be used to contact one or more pagers. A satellite transmitter may also be used, such as the type now available for use with satellite based phone systems. Any of these or other wireless communication devices may be used alone, or in combination with the GPS receiver 180.

A wireless receiver 200 may also be located within the enclosure 35 and placed in electrical communication with the microprocessor 150, 175 shown in FIGS. 4-5 above. The wireless receiver 200 can be used to allow for communication with a wireless transmitting remote control device, such as a key fob, thereby permitting, for example, arming/disarming of the security cable 5 and/or activation/deactivation of a motion detector. The wireless receiver 200 may also allow the security cable 5 to communicate with other remote wireless transmitting devices, such as, for example, remote motion sensors (not shown). If the security cable 5 is used in conjunction with other remote sensors, a communication from one or more of the sensors to the wireless receiver 200 may be used to cause the transmission of an alarm signal from the security cable. Thus, the security cable 5 may be used with optional accessories to expand its zone of protection.

A further feature of the wireless transmitting security cable 5 of the present invention may include one or more indicator lights 210. Indicator lights 210 may be located on the enclosure 35 to provide information to the user of the wireless transmitting security cable 5. The indicator lights 210 may be used to indicate, for example, the condition of the power supply (battery) 115, armed/disarmed status, the availability of cellular or other wireless communication services at a particular location, whether an alarm transmission has been sent, and whether confirmation of the receipt of such an alarm transmission has been returned.

As mentioned above, it is preferable that the power supply 115 be a rechargeable battery, although the non-chargeable variety may also be employed. When a rechargeable battery is used, it is preferable that an adapter (not shown) or other device be provided on the enclosure 35 which will allow the battery to be connected to a recharging power source without removal from the enclosure. Alternatively, the security cable 5 may be adapted to recharge the battery 115 by plugging one end of a cable section 15, 20 into a power source.

The wireless transmitting security cable 5 of the present invention functions to provide alarm based protection of transportable and other items. In use, the user of the security cable 5 places the cable around or through, or otherwise secures the cable to an item to be protected. The plug ends 25, 30, whatever their particular configuration, are then joined to form a complete loop. When the security cable 5 is configured with a control portion as shown in FIG. 3, the security cable will thereafter be activated. If the security cable 5 is provided with a keypad, other type on/off switch, or a remote arming/disarming device, the user then properly energizes the security cable after connection of the plug ends 25, 30. Once the security cable 5 is energized, any attempt to disconnect the plug ends 25, 30, cut the cable portion 10, or destroy the enclosure 35 will result in an alarm signal.

The alarm signal may be generated in several ways, depending on the specific configuration of the control portion 40, 140, 170 of the security cable 5. For example, the security cable 5 may be constructed to form a normally closed circuit upon connection of the plug ends 25, 30. In this embodiment, any disconnection of the plug ends 25, 30 or severing of the cable while the cable is energized, will open the circuit and generate an alarm signal. The security cable may also be constructed to monitor resistance within the cable portion 10. A resistor (not shown) may be connected between the contact terminals 105, 145 for this purpose. Monitoring resistance is a preferable method of detecting a breach of the security cable 5, as it prevents the simulation of a closed circuit through the placement of a jumper between the first and second sections of cable 15, 20.

Depending on the configuration of the control portion 40, 140, 170 of the security cable 5, the alarm signal generated thereby may be sent, for example, to the user of the security cable, to a call station or central monitoring station of a security monitoring company, or to one or more other locations selected by the user. If the control portion 40, 140, 170 relies on an existing alarm system, the existing alarm system must be programmed to monitor the security cable 5. Alternatively, if the control portion 40, 140, 170 provides independent alarm signal transmission, such as is shown in the embodiments of FIGS. 4-5, then the security cable 5 is fully operational once energized.

The present invention recites a wireless transmitting security cable that may be used to provide alarm based security monitoring that is especially applicable to transportable property, such as, for example, construction equipment, trailers, motorcycles or bicycles. The wireless transmitting security cable of the present invention may be used in conjunction with an existing hard-wired or portable alarm system, or, in certain embodiments, may function to provide independent alarm based security monitoring of property to which it is affixed. The wireless transmitting security cable of the present invention may be of various shape, size and construction, may utilize various types of wireless alarm transmission, and may also employ a GPS receiver to provide location data.

Therefore, while certain embodiments of the present invention are described in detail above, the scope of the invention is not to be considered limited by such disclosure, and modifications are possible without departing from the spirit of the invention as evidenced by the following claims:

What is claimed is:

1. A wireless transmitting security device comprising:
an enclosure;
a conductive cable adapted to form a complete circuit;
a power supply secured within said enclosure and in electrical communication with said conductive cable;
a sensor secured within said enclosure and in electrical communication with said conductive cable; and
a communications device secured within said enclosure and in electrical communication with said sensor;
wherein said sensor is adapted to react to a change in one or more characteristics of said conductive cable; and
wherein said communications device is adapted to initiate and complete a wireless transmission to a remote location in response to said reaction of said sensor.

2. The wireless transmitting security device of claim 1, further comprising a protective cover substantially encasing said conductive cable.

3. The wireless transmitting security device of claim 3, wherein said protective cover is of metallic construction.

4. The wireless transmitting security device of claim 1, further comprising a means for connecting free ends of said conductive cable to form said complete circuit.

5. The wireless transmitting security device of claim 1, wherein said monitored characteristic of said conductive cable is the presence of current.

6. The wireless transmitting security device of claim 1, wherein said monitored characteristic of said conductive cable is resistance.

7. The wireless transmitting security device of claim 1, wherein said remote location is an existing alarm system.

8. The wireless transmitting security device of claim 7, wherein said existing alarm system is a hard-wired alarm system, said hard-wired alarm system adapted to receive a wireless alarm transmission from said communications device and to initiate an alarm transmission to a remote location thereupon.

9. The wireless transmitting security device of claim 7, wherein said existing alarm system is a portable alarm system, said portable alarm system adapted to receive a wireless alarm transmission from said communications device and to initiate and complete a wireless transmission to a remote location thereupon.

10. The wireless transmitting security device of claim 7, further comprising indicator lights on said existing alarm system for indicating the status of said wireless transmitting security device.

11. The wireless transmitting security device of claim 1, wherein said communications device is a radio frequency transmitter.

12. The wireless transmitting security device of claim 1, further comprising a microprocessor located within said enclosure and in electrical communication with said power source, said sensor and said communications device.

13. The wireless transmitting security device of claim 12, wherein said communications device is a cellemetry radio modem.

14. The wireless transmitting security device of claim 12, wherein said communications device is a cellular transceiver.

15. The wireless transmitting security device of claim 12, further comprising a GPS receiver in communication with said microprocessor.

16. The wireless transmitting security device of claim 12, further comprising a wireless receiver in electrical communication with said microprocessor, said wireless receiver adapted for communication with one or more remote wireless transmitting devices.

17. The wireless transmitting security device of claim 16 wherein said one or more remote wireless transmitting devices includes a remote control.

18. The wireless transmitting security device of claim 17, wherein said remote control is adapted to turn said power source on or off.

19. The wireless transmitting security device of claim 17, wherein said remote control is adapted to arm or disarm a motion detector.

20. The wireless transmitting security device of claim 17, wherein said remote control has a panic feature which allows for instant activation of one or more alarm reporting functions.

21. The wireless transmitting security device of claim 1, wherein said one or more remote wireless transmitting devices includes a remote motion sensor.

22. The wireless transmitting security device of claim 1, wherein said enclosure is constructed of plastic.

23. The wireless transmitting security device of claim 1, wherein said enclosure is constructed of a metallic material.

24. The wireless transmitting security device of claim 1, further comprising an audible siren.

25. The wireless transmitting security device of claim 1, further comprising a strobe light.

26. The wireless transmitting security device of claim 1, further comprising a motion detector for detecting unauthorized movement of said enclosure.

27. The wireless transmitting security device of claim 1, further comprising one or more indicator lights for providing status information.

28. The wireless transmitting security device of claim 27, wherein said one or more indicator lights indicate the status of said power source.

29. The wireless transmitting security device of claim 27, wherein said one or more indicator lights indicate the availability of cellular service.

30. The wireless transmitting security device of claim 27, wherein said one or more indicator lights indicate the status of other wireless transmitting devices.

31. The wireless transmitting security device of claim 1, wherein said power supply is a battery.

32. The wireless transmitting security device of claim 25, wherein said battery is rechargeable.

33. The wireless transmitting security device of claim 1, further comprising a programmable keypad.

34. The wireless transmitting security device of claim 1, further comprising a tamper switch for detecting unauthorized entry into said enclosure.

35. The wireless transmitting security device of claim 1, wherein said conductive cable may be substantially retracted into said enclosure.

36. A wireless transmitting security cable comprising:
an enclosure;
a conductive cable having free ends;
a connector attached to each of said free ends, said connectors adapted to join said free ends of said conductive cable;
a power supply secured within said enclosure, said power supply for providing voltage to said conductive cable;
a sensor secured within said enclosure and in communication with said conductive cable, said sensor adapted to monitor at least one electrical characteristic of said conductive cable after said free ends are connected; and
a communications device secured within said enclosure and in electrical communication with said sensor;
wherein said communications device is adapted to initiate and complete a wireless alarm transmission to a remote location in response to the detection of a change in said at least one electrical characteristic of said conductive cable by said sensor.

37. The wireless transmitting security cable of claim 36, further comprising a microprocessor located within said enclosure and in electrical communication with said power source, said sensor, and said communications device.

38. The wireless transmitting security cable of claim 37, further comprising a GPS receiver in communication with said microprocessor.

39. The wireless transmitting security cable of claim 37, further comprising a wireless receiver in electrical communication with said microprocessor, said wireless receiver adapted for communication with one or more remote wireless transmitting devices.

40. The wireless transmitting security device of claim 37, further comprising a motion detector for detecting unauthorized movement of said enclosure.

41. The wireless transmitting security device of claim 36, further comprising an audible siren.

42. The wireless transmitting security device of claim 36, further comprising a strobe light.

43. The wireless transmitting security device of claim 36, further comprising a tamper switch for detecting unauthorized entry into said enclosure.

44. The wireless transmitting security device of claim 36, further comprising one or more indicator lights for providing status information.

45. The wireless transmitting security device of claim 36, further comprising a programmable keypad.

46. The wireless transmitting security device of claim 36, wherein said power supply is a rechargeable battery.

47. A method of providing alarm-based wireless security monitoring for transportable items, comprising:
providing a wireless transmitting security cable, said security cable further comprising:
an enclosure;
a power source secured within said enclosure;
a conductive cable energized by said power source;
a sensor secured within said enclosure and adapted to monitor at least one electrical characteristic of said conductive cable; and
a communications device adapted to initiate and complete a wireless transmission to a remote location upon a detection of a change in condition of said at least one electrical characteristic of said conductive cable monitored by said sensor;
removably affixing said wireless transmitting security cable to an item to be protected via said conductive cable;
arming said wireless transmitting security cable;
providing a location for receiving an alarm transmission originating from said wireless transmitting security cable; and
responding to receipt of said alarm transmission in some manner.

48. The method of claim 47, further comprising the use of an existing alarm system to communicate with said wireless transmitting security cable, said existing alarm system adapted to receive an alarm transmission from said wireless transmitting security cable and to communicate the existence of said alarm transmission to a pre-determined remote location in response thereto.

49. The method of claim 47, further comprising a microprocessor located within said enclosure and in electrical communication with said power source, said sensor, and said communications device.

50. The method of claim 49, wherein said communications device is able to initiate and complete a wireless alarm transmission to a remote location without the need for an existing alarm system.

51. The method of claim 49, further comprising the use of a GPS receiver in communication with said microprocessor, said GPS receiver allowing location data to be sent in conjunction with said alarm transmission.

52. The method of claim 49, further comprising securing a motion detector within said enclosure, said motion detector for detecting unauthorized movement of said enclosure.

53. The method of claim 47, further comprising providing a siren located within said enclosure for producing an audible indication of a security breach.

54. The method of claim 47, further comprising providing a strobe light located on said enclosure for producing a visual indication of a security breach.

55. A security cable comprising:
an enclosure;
a conductive cable adapted to form a complete circuit;
a power supply secured within said enclosure and in electrical communication with said conductive cable;
a sensor secured within said enclosure and in electrical communication with said conductive cable; and
a warning device in electrical communication with said sensor;
wherein said sensor is adapted to react to a change in one or more characteristics of said conductive cable; and
wherein said warning device is adapted to produce an alarm signal in response to said reaction of said sensor.
